(19) United States
(12) Patent Application Publication
(10) Pub. No.: US 2015/0003511 A1
(43) Pub. Date: Jan. 1, 2015

(54) WEAV Video Super Compression System

(71) Applicants: Christopher Carmichael, San Juan Capistrano, CA (US); Connie Jordan, San Juan Capistrano, CA (US); Kristian Sandberg, San Juan Capistrano, CA (US)

(72) Inventors: Christopher Carmichael, San Juan Capistrano, CA (US); Connie Jordan, San Juan Capistrano, CA (US); Kristian Sandberg, San Juan Capistrano, CA (US)

(21) Appl. No.: 13/305,304

(22) Filed: Nov. 28, 2011

Related U.S. Application Data
(60) Provisional application No. 61/417,378, filed on Nov. 26, 2010.

(51) Int. Cl. H04N 19/136; H04N 19/176; H04N 19/625; H04N 19/186

(52) U.S. Cl. CPC H04N 19/00139; H04N 19/00315; H04N 19/00278; H04N 19/00812
USPC 375/240.02

(57) ABSTRACT

A compression system using supercompression.

This application claims priority from provisional application No. 61/417,378, filed Nov. 26, 2010, the entire contents of which are herewith Incorporated by reference.

### BACKGROUND

Compression can be used to reduce the size of video and/or images that are sent over a network.

### SUMMARY

An embodiment describes a coding scheme and hardware (codec) which uses a special kind of compression referred to as “super compression”. The codec as described herein has, the ability to compress, restore, and rescale images, and to allow object tracking of features in a scene.

An embodiment describes the ability to decompose an image into several components; edges, texture, and a correction.

Another aspect is once decomposed, the correction itself may be compressed.

### BRIEF DESCRIPTION OF THE DRAWINGS

FIG. 1 shows a block diagram of the compression;

FIG. 2 shows a flowchart of the overall compression techniques;

FIG. 3 shows a flowchart of edge detection and texture detection flowcharts;

FIG. 4 shows a flowchart of color transform and encoding;

FIG. 5 shows a flowchart of edge mapping;

FIGS. 6A-6E show different images and the different corrections for a landscape type picture;

FIGS. 7a-7e show images and compression for a sports type image;

FIGS. 8A-8E show images and compression for a person;

FIGS. 9A-9C shows examples of the compression that is carried out;

FIGS. 10A-10C show image resizing;

FIGS. 11A-11C show noisy thumbnail resizing; and

FIG. 12 shows temporal compression.

### DETAILED DESCRIPTION

The present application describes techniques for super compression of video, including, but not limited to, hardware device or software device carrying out the functions of the code. A super compression codec not only compresses the information, but also allows zooming, restoration, object tracking, and embedding of multimedia content (such as advertisement) in video.

One embodiment carries out separation of edges and textures from the image as a starting point for efficient compression, re-scaling capabilities, restoration, and object tracking.

Another embodiment describes techniques for carrying out the compressibility of a “correction stream” that can be thought of as “what is left of an image once the edges and textures have been extracted”.

Another component of the first phase has been to implement a resizing and restoring technique for some simple test images.

Two initial techniques include image separation and compression of the correction.

Image Decomposition

Image decomposition in a first embodiment refers to decomposing an image into three components. The first and second components include the large scale edges in the image and the texture. Examples of texture include foliage, hair, and fabric. In principle, the image can be reconstructed from the texture and edges by using the so-called Inverse Poisson Transform, as described herein. However, when compressing the edges and texture using just this technique, the reconstructed image will not be correct. The difference between the true image and the reconstructed image constitutes the third component of our image decomposition, which we refer to as the (low frequency) correction.

To summarize, the image will be decomposed into the following three components:

Edges,

texture, and

low-frequency correction.

The inventors found several reasons why decomposing the image is important for super compression.

Commonly used compression tools are typically designed as a “compromise” in the sense that it does a good but sub-optimal job on compressing a mixture of edges, textures, and low-frequency corrections. By separating out these components, one can use specialized, near-optimal compression tools for each of these components.

Object tracking. Separating out the edges of an image is helpful in identifying the border of objects in a scene, and hence facilitates tracking of objects in a scene. This can be, e.g., be used to track objects that have been tagged for advertisement applications.

Motion compensation. Motion compensation in video is currently typically done by tracking rectangular regions in an image. As it is more natural for our eyes to track objects in a scene, object tracking facilitated by edge separation will allow motion compensation to be done in a way that fits the human visual system more naturally.

Re-scaling. By a suitable representation of the edges (see Section 5.2 below), edges can be up-scaled to finer resolution in a way that does not introduce pixelation.

Restoration. In cases where edges have been degraded by, e.g., poor focus or compression artifacts, the edge representation can be used to estimate the true (original) edge, and be used as a foundation for restoring degraded footage.

According to an embodiment, previously compressed or uncompressed video 100 is input into a super compression codec 110 which carries out in software or hardware or firmware the techniques described herein. The codec then outputs compressed video 120, which may be compressed and also may be zoomed or otherwise transitioned into a different form which may be applicable to a different display device that will eventually display the codec-converted image.

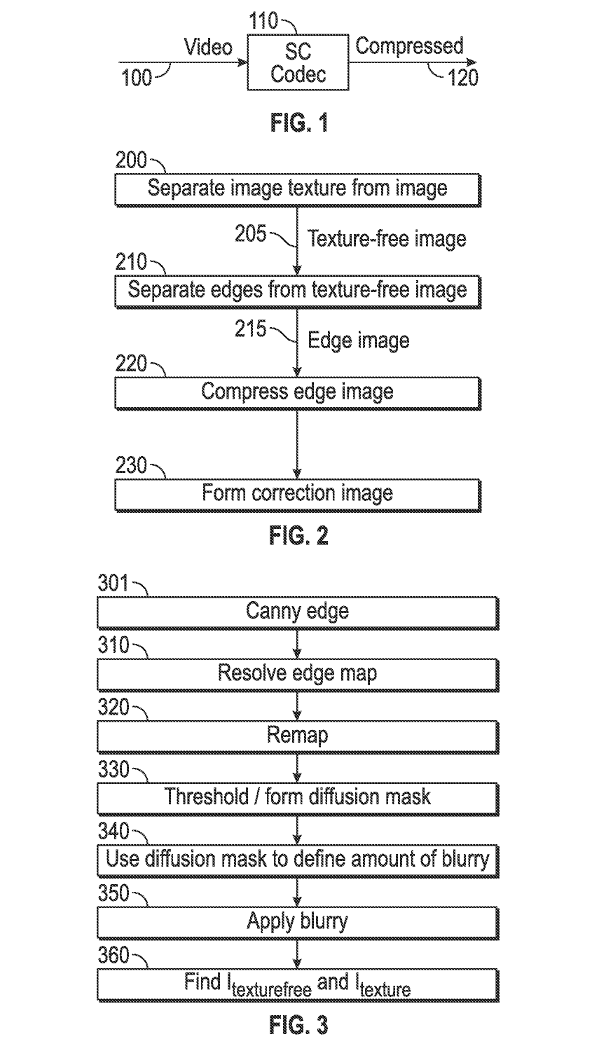

FIG. 2 illustrates a flowchart of the operation.

At 200, the texture of the image is separated from the rest of the image such that

IMAGEtexture-free=IMAGEoriginal−IMAGEtexture.

The image part is left after separating the texture is called the texture free image. Which is output is 205. At 210, the edges are separated from the texture free image IMAGEtexture-free resulting in what we refer to as IMAGEedges. That is a file that has edges only also called an edge image output as 215.

At 220, the edge image is compressed using a compression denoted C. This creates a reconstruction of the texture free image by using the inverse of the Poisson transform P, that is,

IMAGErec=P−1(C(IMAGEedges)). (3.1)

At 230, the low frequency correction image as the remainder of what is left when the texture free image is separated from the reconstruction image.

IMAGEcorr=IMAGEtexture free−IMAGErec

Note that the original image can now be reconstructed by

IMAGEorig=IMAGErec+IMAGEtexture+IMAGEcorr.

That is, the original image can be formed from the reconstruction image plus the textures, plus the low frequency correction. These items can be obtained and compressed separately.

Texture Separation

The texture free image at 200 is computed by the codec executing the following operations:

Detect the edges using a Canny edge detector at step 301.

At step 310, the system operates Rescale the resulting edge map to the intensity 0 to 1, where 0 indicates no edge, and 1 indicates a strong edge.

At step 320 the resealed edge map ledge is remapped to the diffusion mask M which is defined as M≡1. (Fixed the array (Since ledge is an array, the operations are applied element-wise.)

Iedge+1

at step 330, the diffusion mask is thresholded by setting values in the diffusion mask below a certain threshold to 0.

340 illustrates that the diffusion mask is used to define the amount of blurring at each location of the image. (A diffusion mask value of 0 indicates no blurring, and a diffusion mask value of 1 indicates strong blurring.)

At 350, the amount of blurring is applied, for example Apply blurring (using, e.g., a linear diffusion process a.k.a. Gaussian blurring) at each location according to the value of the diffusion mask at that location.

Now, at 360, the (non-uniformly) blurred image will be essentially “texture free” (denoted as Itexture free) and the difference between the original image and the texture free image will contain the texture (denoted as Itexture).

Edge Separation

Once the texture free image has been computed, the edges are extracted by applying the Laplacian operator

$$Δ ≡ \frac{{\partial }^{2}}{\partial {x}^{2}} + \frac{{\partial }^{2}}{\partial {y}^{2}}$$

to the texture free image.

Low Frequency Correction

To construct the low frequency correction, we first compress the edge map ledge. This can be done in many ways, using a compression operator that is denoted as C. By inverting the Poisson transform P, an approximation of the texture free image by Equation (3.1) is obtained.

This image will typically look like the texture free image, but with non-uniform contrast (darker in the center and brighter at the edges). The difference in contrast between this approximation and the original texture free image can typically be represented as an image with mainly low-frequency content, and we therefore refer to this difference as the low frequency correction image.

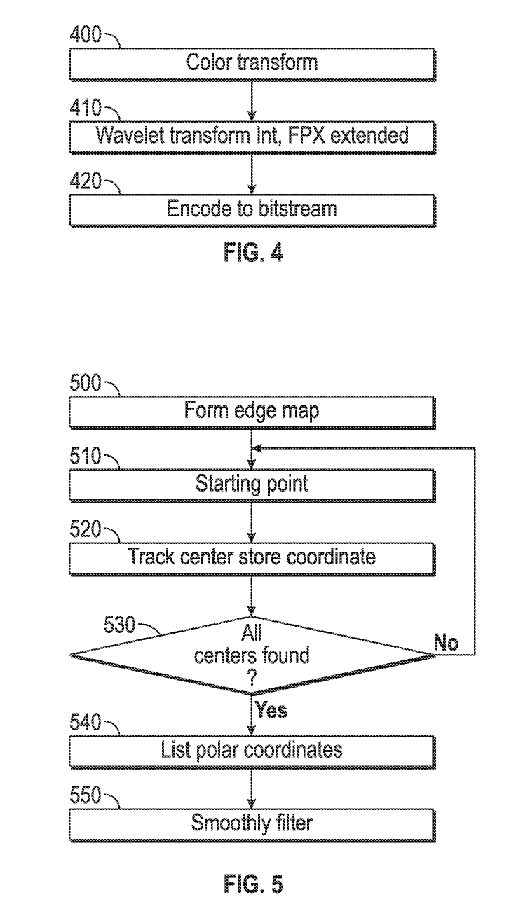

the compression in 220 carries out a series of transformations to each video frame as shown in FIG. 4. The first is a color transform at 400.

In conventional color images, Each frame of a color video consists of a red, a blue and a green image. If we look at these 3 images, their content is recognizable. This means the same information is encoded in each of the 3 channels forming the three different primary colors. The color transform is used to minimize the amount of information shared between channels.

For this phase, the inventors performed 15 different types of color conversions, and tested over 300 images. It was found that, on average, we can gain 0.43 PSNR versus the YYC transform by choosing the YCrCb transform. For this function, this transform is therefore believed to be one which can improve the operation. We believe also that this would improve our player's decoding speed by around 10%.

Alternatively by choosing the Discrete Cosine Transform (DCT) we can gain 0.82 dB. If the encoder allows multiple transforms (informing the decoder which to choose), the overall gain by choosing Discrete Hartley Transform (DHT), DCT, and YCoCg on a per frame basis is 1.1 dB. As a rule of a thumb, a gain greater than 0.5 dB is considered a “significant” improvement in quality.

After performing the color transform, we apply a wavelet transform at 410. For this phase, we supply three types of wavelet transforms: integer, floating point, and extended. The extended transform is new. Classical wavelet transforms have poor behavior near the edges of images, effectively encoding the fact that the image has an edge. This useless information ends up in the compressed data, wasting bits. We have developed an extended wavelet transform that does not encode this information, at the cost of extending the image size by one pixel horizontally and vertically.

Finally the wavelet transform coefficients are encoded into a bitstream at 420. The algorithm here is a reimplementation of that of the initial Weav codec with some extensions. The new encoder supports odd sized lowest frequency bands which improves the compression on certain image ratios by 75%. We also have support of 720p and 1080p sizes. The encoder outputs additional information that allows the bit stream to be partitioned according to the function each bit serves. This will allow us to merge bitstreams with similar entropy characteristics. The decoder can read any number of these merged streams and combine them appropriately. The encoder also outputs an error measure (measured as peak signal to noise ratio a.k.a. PSNR) and thresholding information that can be used to cut the bitstream when a certain threshold is reached, or when the error measure in wavelet space exceeds some value.

In order to aid development, each component of the compression is separated into its own tool. This makes it easier to understand each component and validate each independently. Because the tools are command line based they can be scripted. This makes it easier to try out different ideas. Each tool can display its output immediately so that one can immediately check its results visually rather than open another tool to see them. We have also written a tool to measure the quality of our output in terms of PSNR and the Structural SIMilarity index (SSIM). The PSNR measure compares individual pixels, emphasizing large differences between them. Improving the PSNR for any given codec improves visual appearance. It is also a standard metric used to compare codecs numerically. However it is limited in that a codec may produce better looking images while being beaten by another in terms of pure PSNR. The SSIM measure compares the structure of images including edges. It is more costly to compute but appears often to simulate human perception better.

Resizing and Restoration

Part of the advantage of this codec is the ability to resize and restore images on the fly. Image resizing can be very useful when different clients may be simultaneously receiving the same image. For example, if a cell phone client is getting the image, it may be useful to be able to use the codec for resizing the image to a cell phone size. In contrast, an image obtained from the cell phone can be enlarged to be played on a larger screen.

One of our goals with super compression, is to resize (enlarge) images without introduce pixelation (blocking) artifacts. We first note that pixelation artifacts tend to be most visible along edges in the image. Keeping this in mind, let us now study how resizing works on each of our image components:

Low-frequency correction. The low-frequency correction does not contain any edges, but the image is smooth. Smooth images can quite easily be resealed without introducing pixelation artifacts.

Edges. Rather than representing edges as a collection of pixels, we represent an edge as a list of coordinates. When resizing an edge, we do this by resizing

along the edge by interpolating the list of coordinates. Furthermore, one can filter the coordinate list to remove any “jaggedness” that might occur when generating the list of coordinates.

Texture. Texture is difficult to resize regardless of method. However, the human visual system is typically quite insensitive to errors in the texture, so for the texture it is not as crucial how it is resized, compared to the edges.

To summarize, our ability to decompose edges from the rest of the picture allows us to use a “resizing friendly” representation for the edges. In contrast, traditional resizing methods rely on interpolating the pixels in the horizontal and vertical directions, without any regard to whether the pixels belong to an edge or not.

For this phase, we have developed an algorithm that finds a representation of an edge that works as follows and as shown in FIG. 5:

At 500, the image is first edge detected by applying the Canny edge detection algorithm to obtain a binary representation of the edges in an image (edge map).

A starting point is selected at 510 and along one of the contours in the edge map. This can be done, for example, automatically by one of the conversion devices. This can be done automatically.

At 520, the contour is tracked from the starting point, until all points along the contour have been found. The contour coordinates are stored in a list in a list.

530 shows checking to see if all the contours of been found, and if not 510 in 520 are repeated until all the contours are found in the attachment.

Once all the contours of been found, the list of contours is represented in polar coordinates at 540. An optional smoothing filter can then be applied at 552 to a list of radial coordinates.

Once we have such a representation, each pixel coordinate can be mapped to real numbers, and then scaled to any size. If necessary, the list can also be interpolated to increase the sampling rate of the contours.

Once we have a list of coordinates, we can extract the gradient direction by computing the tangent at any point of the contour and obtain the normal direction as the orthogonal direction to the tangent. We then record the intensity jump (gradient) along the normal direction, that we store in a separate list. This list can then be filtered, which effectively will result in de-noising the image.

The result of this algorithm is demonstrated herein

4.1 Image Decomposition

In this section we demonstrate the image decomposition described in Section 3.1. For each test image, we present the original image along with a montage with four images:

the texture-free image,

the extracted texture,

the edges, and

the correction.

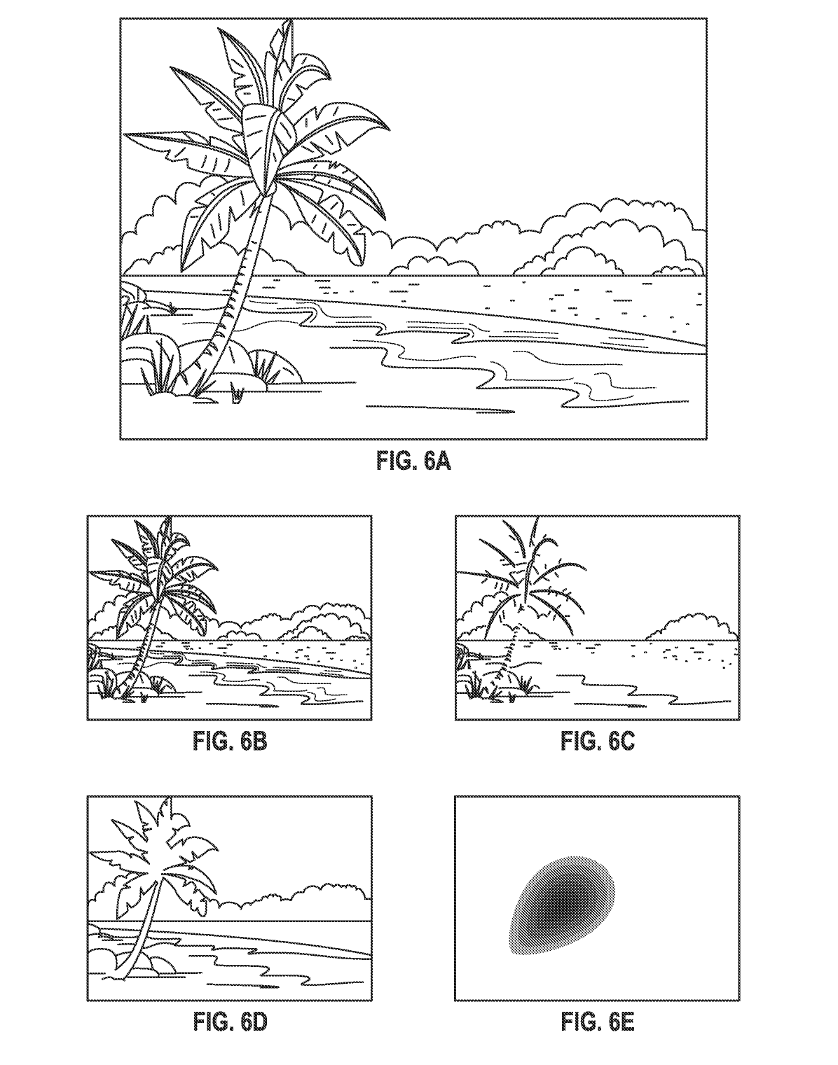

FIGS. 6A-6E represent respectively the original image at a resolution of 640-by-320. The texture free image, the extracted texture, the correction, the edges, and the correction. FIG. 6A-6E shows this for a nature image.

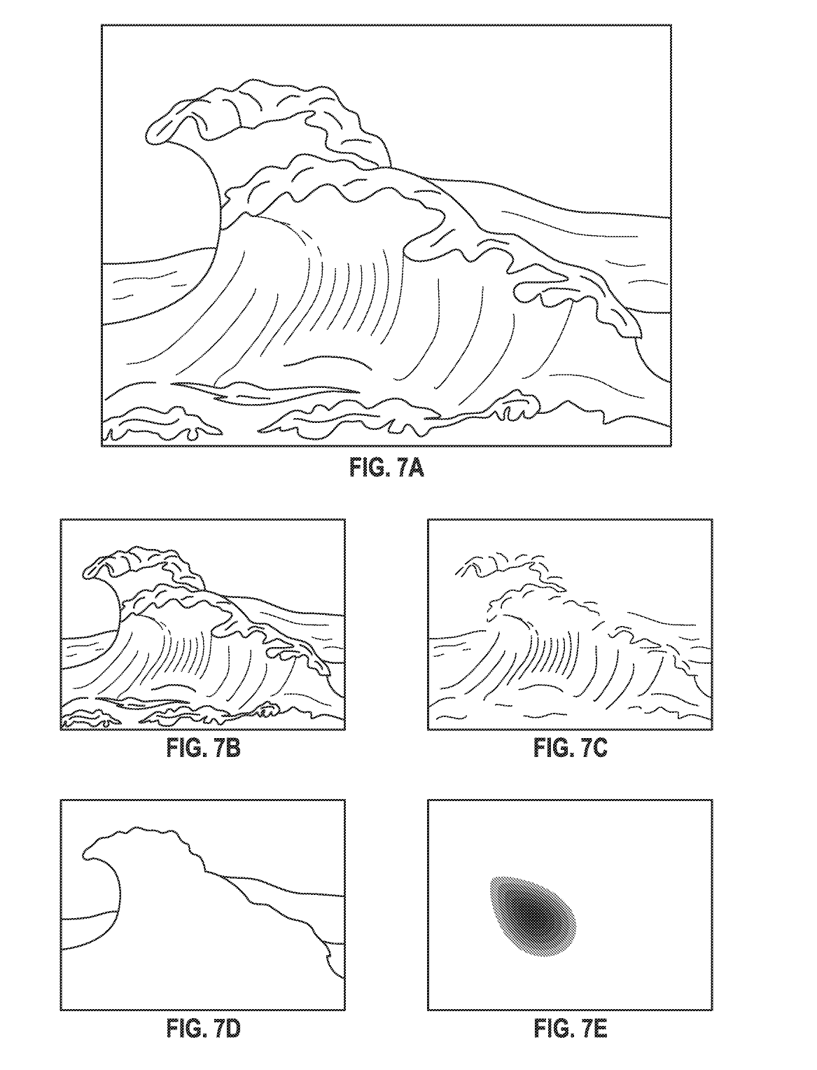

FIGS. 7A-7E show a sports image at a resolution of 512×384. The original image is shown in FIG. 7A. FIG. 7B shows the texture free image. FIG. 7C shows the texture itself. FIG. 7D shows the edges. FIG. 7E shows the correction.

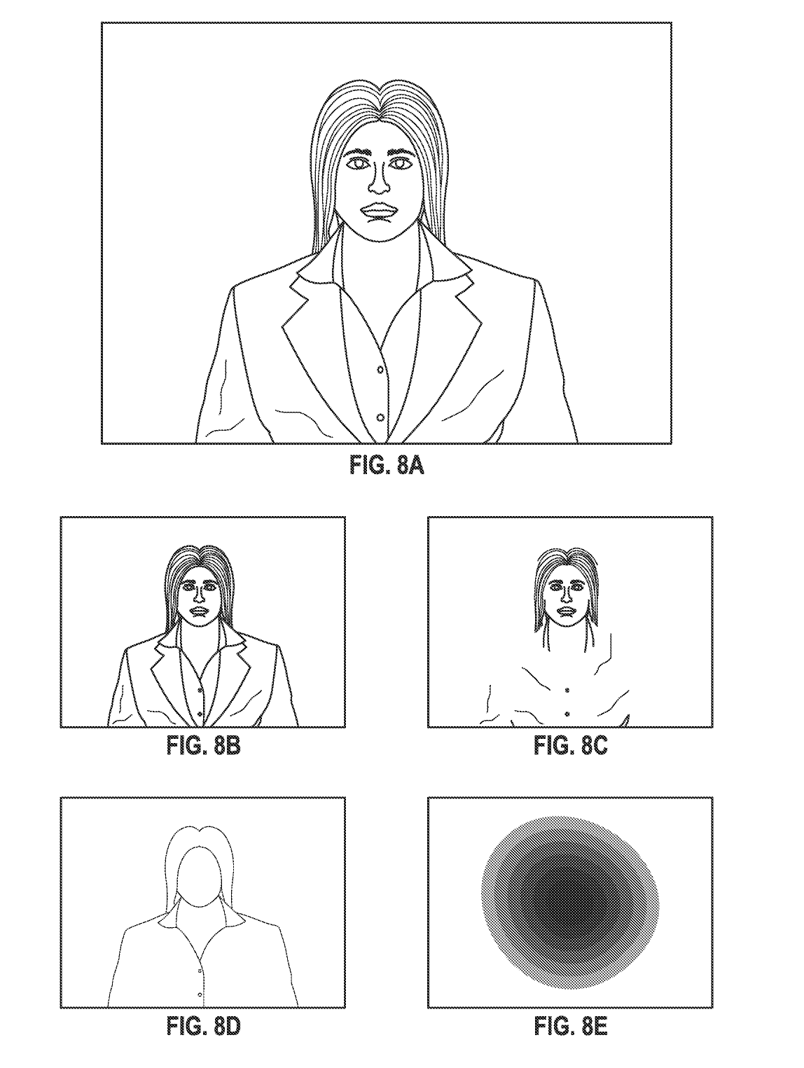

FIGS. 8A-8E show the compression for a talking person with a resolution of 320×240. FIG. 8A shows the original image, while FIG. 8B shows the texture free image, FIG. 8C shows the texture, FIG. 8D the shows the edges, and FIG. 8E shows the corrections.

4.2 Compression

In this section we provide results from compressing the correction according to the method in Section 3.2. The compression ratio was computed according to the formula

$$compression ratio ≡ \frac{24 {\times }^{``} number of {pixels}^{″}}{{}^{``} bits used to represent {correction}^{″}}$$

Note that this measure cannot be directly compared to other compression ratios, as it does not yet take into account compression of the texture nor edges. Nevertheless, it provides a useful measure for internal development and evaluation of the algorithm.

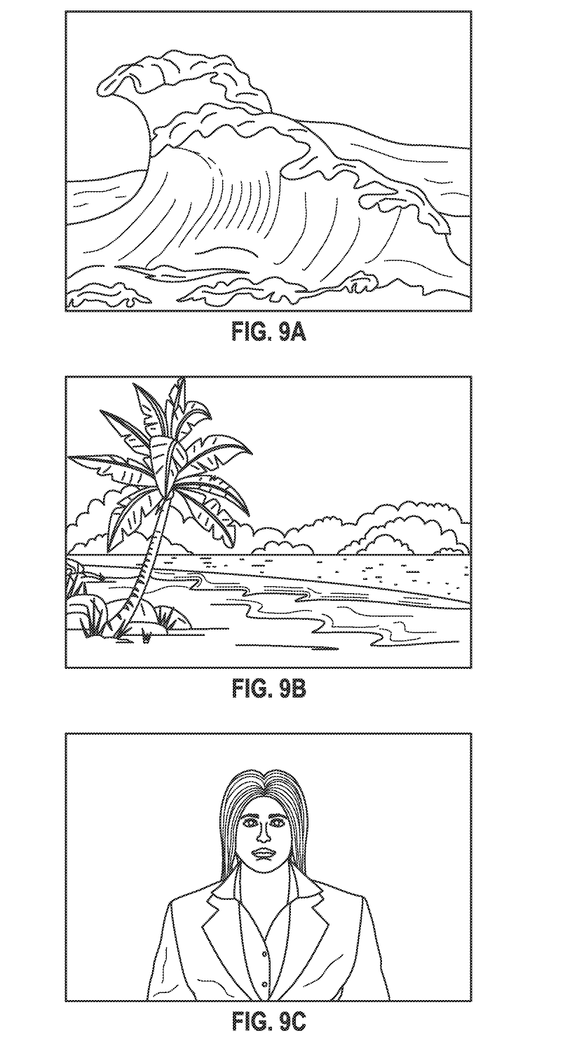

FIG. 9A shows the image of FIG. 7A with compression ratio of 152:1. FIG. 9B shows the image of FIG. 6A with a compression ratio of 230:1. FIG. 9C shows the image in FIG. 8A with a compression ratio of 154 to 1.

In this section we demonstrate the result of the resizing algorithm outlined above.

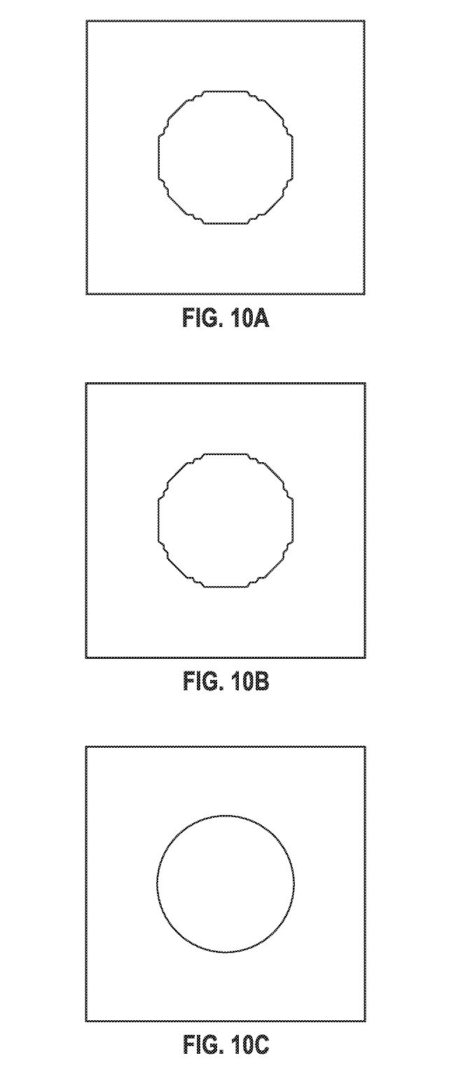

First, we generate a test image “thumbnail” of size 64-by-64 pixels shown in FIG. 10 A.

We next resize this image using the standard technique of bicubic interpolation as shown in FIG. 10B, and compare it to using the WeavSC algorithm as shown in 10C. We note that the WeavSC result is significantly less pixelized compared to the image resized using bicubic interpolation.

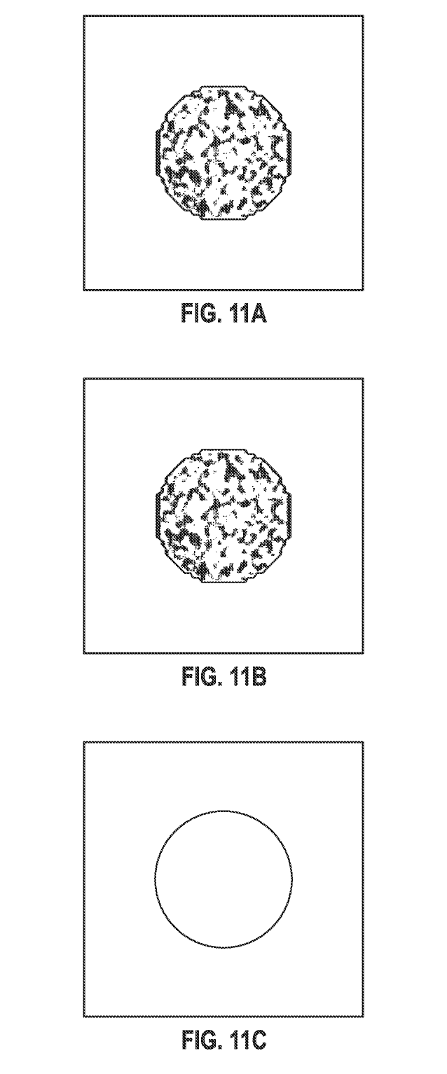

Next, we demonstrate the restoring capabilities of WeavSC. To this end, we add noise to the thumbnail to create the thumbnail shown in FIG. 11A. We next resize this image using the standard technique of bicubic interpolation to create the image shown in FIG. 11B. FIG. 11C shows the image created using the WeavSC algorithm

We note that the WeavSC result is significantly less pixelized compared to the image resized using bicubic interpolation. Moreover, the WeavSC algorithm has completely removed the noise.

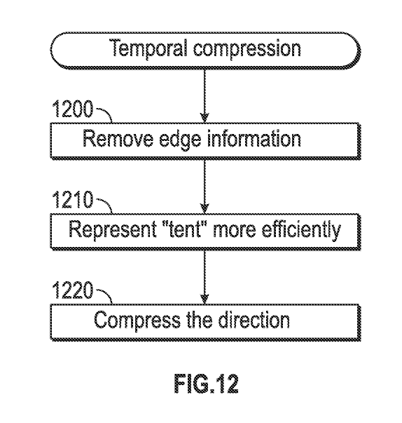

The above embodiments only explored only explored spatial compression of the low frequency correction. When compressing movies, it is also useful to compress the spatial compression temporally (in time). Embodiments as disclosed herein describe several techniques of doing this with reference to the flowchart of FIG. 12.

In general, compressing the correction is easier as the correction contains less edge information. The amount of edge information in the correction depends on the strategy chosen for the edge representation (See below), and the nature of the movie to be compressed. Therefore, FIG. 12 starts out by removing as much of the edge information as possible using the techniques described above at 1200.

Once the edge information is removed, the correction typically has the shape of a “tent”, which represent the non-uniform intensity that results after applying the inverse Poisson Transform. The first step is therefore to represent this tent shape as economically as possible which is carried out in 1210. Here, there are several possibilities, including

Radial Basis Functions,

The Singular Value Decomposition, and

The Discrete Sine Transform (DST).

After the correction has been adjusted for the intensity distribution correction, we next compress the correction at 1220 using with one or more of the following methods:

Alt. 1. Use a 3D wavelet transform on the average subband (“thumbnail”), and slice-wise 2D wavelet transform on the high frequency subband (which varies rapidly in time).

Alt. 2. Use a motion compensation scheme for wavelet transformed data based on the “motion-threading” scheme [4].

Alt. 3 Use matching pursuit on the average frequency band. This is a greedy algorithm from Mallat et. al [2] and is only practical for small images. Matching pursuits have been used to represent residuals at very low bit rates better than standard methods such as the DCT. It uses a sum of Gabor functions which vary smoothly like the low frequency image does.

5.2 Spatial Representation of Edges

In order to represent the edge map, we propose three methods.1

Alt. 1. Represent each edge with a representation of the coordinates along the edge, along with the value of the gradient across the edge. Once we have the coordinate representation, we can generate the tangent and normal direction of the edge, which combined with the gradient magnitude gives us a complete description of the edge, but only 1 or 2 pixels wide. To describe a “thicker” edge, we will also add a blurring parameter at each point. The curve description can then be compressed using (e.g.) wavelet methods applied to the x and y component separately.

Alt. 2. Decompose the image into a quadtree. Each segment of a curve is represented by a leaf of the quadtree. The segment is represented by the angle of the segment and its distance from the center of the quadtree node. The nice thing about this solution is that you can add more depth to the quadtree to get more precision. However because the quadtree divides the image up into halves, you can end up with log (N) additional quadtree leaves that do not add any useful information.

A more complex but more bit-efficient strategy is to use prune-join trees which are explained in Rahul Shulka's PhD thesis: “Rate-Distortion Optimized Geo-metrical Image Processing” [3]. This reduces the number of leaves significantly and costs O(N.log(N)) where N is the number of pixels in the image.

Alt. 3. Represent the edge map with a curvelet, wedgelet, or similar wavelet based approach.

It is possible that we end up using a hybrid of these approaches.

Spatial Representation of Texture

The texture component includes graininess, edges, and texture that has no clear pattern.

Pixels that have a small value, and are poorly correlated between successive frames, are invisible graininess. We can remove this since it is random noise, and therefore uncompressible. (This is a form of temporal rate distortion optimization). Another way of doing this is to use thresholding in the wavelet domain.

One kind of edge occurring in the texture are single edges that do not contribute shading to the overall picture. They can be represented using the edge representation.

A second kind of edge occur in thickets (many edges near each other). For instance the texture of clothing, or the ripples and foam of the sea. These edges are probably best represented by bandelets: wavelets that are warped along the direction of optical flow. Cheaper less effective cousins of bandelets include the EPWT (easy path wavelet transform) and Directionlets.

Since it takes additional bits to represent the optical flow, bandelets/Directionlets/EPWT only compress in areas where the optical flow is relatively smooth. Froth on the top of waves, or the foliage of trees are best represented using a different system. Options include

a wavelet algorithm inspired from SPIHT, EZBC, SFQ, EBCOT, or HIC.

the DCT (as used by JPEG).

Basis functions inferred by PCA or ICA (encoded in a reference frame), ideally determined for a Group of frames (rather than each individual frame).

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other forms of payment cards and devices can be used.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein, may be implemented or performed with a general purpose processor, a Digital Signal. Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format, e.g., VGA, DVI, HDMI, displayport, or any other form.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. The memory storage can also be rotating magnetic hard disk drives, optical disk drives, or flash memory based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Operations as described herein can be carried out on or over a website. The website can be operated on a server computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A compression system using supercompression.
